(19) United States
(12) Patent Application Publication
(10) Pub. No.: US 2011/0274356 A1
(43) Pub. Date: Nov. 10, 2011

(54) IMAGE PATTERN RECOGNITION

(75) Inventors: Tolga Tasdizen, Salt Lake City, UT (US); Antonio R. C. Paiva, Houston, TX (US)

(73) Assignee: UNIVERSITY OF UTAH RESEARCH FOUNDATION, Salt Lake City, UT (US)

(21) Appl. No.: 13/129,110

(22) PCT Filed: Nov. 12, 2009
(86) PCT No.: PCT/US09/64259

§ 371 Date: Jul. 26, 2011

Related U.S. Application Data
(60) Provisional application No. 61/198,940, filed on Nov. 12, 2008.

(51) Int. Cl. G06K 9/46

(52) U.S. Cl. 382/195

(57) ABSTRACT

Image pattern recognition is described. In accordance with one embodiment, a method for image recognition includes dividing an image into blocks in preparation for separating a region of interest of the image from the remainder of the image. The blocks can be analyzed to determine whether a two dimensional projection of data from one or more blocks has a circular shape. The region of interest can be identified by identifying the blocks with circular shaped projections.

### PRIORITY CLAIM

Priority is claimed to PCT Patent Application Serial No. PCT/US2009/064259 filed on Nov. 12, 2009 which claims priority to U.S. Provisional Patent Application Ser. No. 61/198,940 filed on Nov. 12, 2008, which is incorporated herein by reference in its entirety.

### BACKGROUND

Image technicians have long been searching for ways to better analyze and store image data, particularly for use in comparison with other images. For example, some systems have provided for automatic recognition of an image on the basis of a corresponding reference image.

### BRIEF DESCRIPTION OF THE DRAWINGS

FIG. 1 is a block diagram of a system for image pattern recognition in accordance with an embodiment;

FIG. 2 is an image of a fingerprint with highlighted sections illustrating local fingerprint structure;

FIG. 3a is a section of the fingerprint of FIG. 2;

FIG. 3b is a graph illustrating an example of a circular projection of the fingerprint pattern of FIG. 3a;

FIG. 3c is a chart illustrating that most of the variance in the fingerprint pattern of FIG. 3a lies on the first two dimensions;

FIG. 4 is the fingerprint image of FIG. 2 illustrating an example of blocked segmentation;

FIG. 5 is the fingerprint image of FIG. 2 illustrating line detection;

FIG. 6a is a section of the fingerprint of FIG. 2 illustrating fingerprint minutia;

FIG. 6b is a graph illustrating an example of a circular projection of the fingerprint pattern of FIG. 6a, including the projections to the center of the circular shape due to minutia;

FIG. 6c is the fingerprint image of FIG. 2 illustrating an example of detected fingerprint minutia;

FIG. 7 is a flow diagram of a method for image pattern recognition in accordance with an embodiment; and

FIG. 8 is a flow diagram of a method for image pattern recognition including identification of line pattern deviations in accordance with an embodiment.

### DETAILED DESCRIPTION

Reference will now be made to the exemplary embodiments illustrated, and specific language will be used herein to describe the same. It will nevertheless be understood that no limitation of the scope of the invention is thereby intended. Additional features and advantages of the invention will be apparent from the detailed description which follows, taken in conjunction with the accompanying drawings, which together illustrate, by way of example, features of the invention.

As used herein, “adjacent” refers to near or close sufficient to achieve a desired affect. Although direct physical contact is most common and preferred in the structures or volumes of the present invention, adjacent can broadly allow for features which are not in direct contact but which are nearly so.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect on the property of interest thereof.

As used herein, the term “about” is used to provide flexibility to a numerical range endpoint by providing that a given value may be “a little above” or “a little below” the endpoint with a degree of flexibility as would be generally recognized by those skilled in the art. Further, the term about explicitly includes the exact endpoint, unless specifically stated otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation can apply regardless of the breadth of the range or the characteristics being described.

As used herein, the term “manifold” is used to refer to a space that is “modeled on” Euclidean space or a topological space locally homeomorphic to a topological vector space over reals. A manifold can be a mathematical space that, on a small enough scale, resembles the Euclidean space of a specific dimension.

As used herein, the term “projection” is used to refer to any one of several different types of functions, mappings, operations, or transformations of data. For example, a projection may be used to represent a shape, pattern, surface, etc. of an object or image on a plane. A projection can be used to describe a topological space within a topological subspace.

In recent years, research in manifold learning has provided examples of many cases where fundamental characteristics of a set of images can be inferred from the topology of a manifold formed by these images. Manifold learning is a research topic that has received increased attention in recent years, at least in part due to developments in nonlinear dimensionality reduction techniques, such as Isomap®, local linear embedding, Laplacian eigenmaps, and so forth. Manifold learning attempts to derive a characterization of an image using only a few parameters to capture high-dimensional data. Manifold learning can simplify data analysis and image recognition by more easily allowing for visualization of the data and interacting data structures.

Manifold learning aims to infer the structure of data by characterizing the topology of the manifold where the data lies. Typically, high-dimensional data (or some high-dimensional representation as obtained in kernel methods) actually lies in a subspace (i.e., the manifold) that can be described by only a few features. For smooth manifolds with topology equivalent to the Euclidean topology (e.g., where the distance in the manifold is some smooth function of the Euclidean distance in the feature space), an isomorphism exists between the space of features and the manifold. In other words, the dimensionality of the feature space is the number of parameters used to parameterize the manifold, and the isomorphism characterizes the topology. Manifold learning is often applied to datasets where the dimensionality of the feature space is unknown, or to empirically verify the existence of an isomorphism between the perceived parameters and the data. For example, considering a set of images of an object taken at different rotations, manifold learning can be used to verify the existence of a parameterization of the manifold formed by these images in terms of the rotation angle.

Image pattern recognition using manifold learning is described herein. In accordance with one embodiment, a method for image recognition includes dividing an image into blocks in preparation for separating a region of interest of the image from the remainder of the image. The blocks can be analyzed to determine whether a two dimensional projection of data from one or more blocks has a circular shape. The region of interest can be identified by identifying the blocks with circular shaped projections. Features of the region of interest can be identified by detecting lines and minutiae within the region of interest.

Image pattern recognition as described herein can be performed using a prior knowledge of a particular manifold topology. Certain manifold topologies exhibit at least semi-regular patterns. In other words, these manifold topologies may include repetitive or semi-predictable features or may have periodic or cyclic qualities. For example, fingerprints generally comprise a regular and a characteristic pattern. A local segment of a fingerprint generally comprises a series of substantially straight, parallel lines. Although fingerprint images are described as a primary example application of the image pattern recognition described herein, the image pattern recognition systems and methods may be used to recognize image patterns in a wide variety of applications in which images having a series of lines or repetitive features are used. For example, seismic images of an underground topology showing sedimentary layers of dirt, minerals, etc. can be used by the image pattern recognition systems and methods described herein in discovering information about potential or known natural resources, such as natural gas or oil reserves because the sedimentary layers can often be characterized by patterns of substantially straight, parallel lines. Patterns or features within the patterns recognized from the images can be compared with known characteristic patterns or features to identify a match. For example, recognized fingerprint pattern features can be compared with other fingerprint pattern features to see if there is a match, or known topological features indicative of oil reserves can be compared with recognized underground topological features to assist in identifying the presence of an oil reserve.

Knowledge of a topology of a manifold can provide a systematic approach through which different problems may be approached in a unifying manner. Specifically, for each problem, prior knowledge of a regular manifold structure can be used in selecting and defining a set of optimal features which can characterize local properties of an image from the properties of the manifold. To illustrate these concepts in the case of fingerprint analysis, the problems of segmentation, ridge detection and minutia detection are considered.

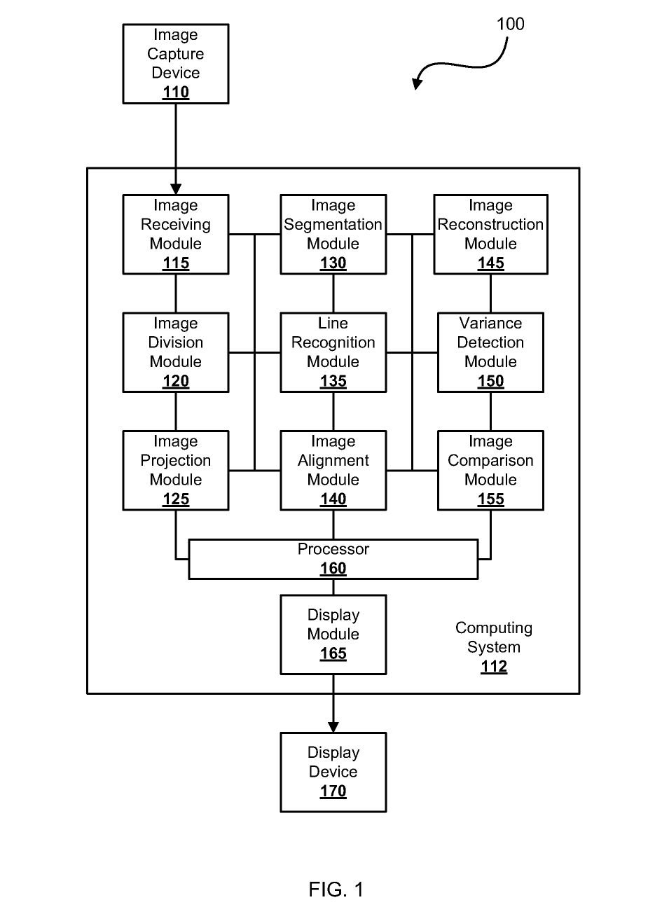

FIG. 1 illustrates a block diagram of a system 100 for image pattern recognition in accordance with an embodiment. An image capture device 110 can be utilized to capture an image. The image capture device may comprise any suitable form of image capture device known in the art, and may include devices such as cameras or scanners, among others. In the case of fingerprint analysis, the image capture device may comprise a fingerprint scanner. In one aspect, the image capture device can be a device capable of detecting an image and providing the image to the system in a digital format. The image capture device can be coupled to or coupleable to a computing system 112 configured to recognize patterns in the image. For example, the image capture device can be optically or electronically coupled or coupleable to the computing system via wired or wireless transmission devices.

As used herein, the terms “computing device” or “computing system” are used to refer to an electronic device or system configured to recognize image patterns. In one aspect, the computing device may comprise a computer or series of computers, or may comprise one or more computing networks or one or more computers across one or more networks. In various embodiments, the computing device may comprise a processor, a storage device, memory, buses, and so forth.

The system 100 may comprise an image receiving module 115. The image receiving module can be configured to receive the image captured by the image capture device 110. The image receiving module can be on the computing device 112 or in communication with the computing device. As has been described, the system can be used to recognize images comprising fairly regular patterns, such as may be the case with fingerprints or other images. In one example, the image may at least partially comprise a line pattern.

The image receiving module 115 can be in communication with an image division module 120. The image division module can be configured to divide the image into a plurality of sections. For example, the image division module may divide the image into a plurality of blocks. The blocks can be used for image analysis or processing. For example, as will be described, the blocks can be used to segment a region of interest in the image from the remainder of the image. The blocks can be adjacent, overlapping, or separated by a predetermined distance. The blocks can be any predetermined size or shape. In one aspect, the blocks can be square blocks and may comprise a 16×16 pixel region.

Block-wise and pixel-wise segmentation are two approaches for fingerprint segmentation. In pixel-wise segmentation, each pixel can be classified independently. A drawback of pixel-wise segmentation is that pixel-wise segmentation generally uses more system resources for computation than is used in a block-wise approach. Many pixel-wise approaches operate as filters considering individual pixels. Block-wise approaches generally utilize image blocks. Pixel-wise approaches can also utilize image blocks with the primary difference from block-wise approaches being that the pixel-wise approach essentially considers substantially overlapping blocks offset by one pixel space while the block-wise approach generally considers adjacent, non-overlapping blocks. Combinations of these or other approaches may also be used in dividing the image for image analysis or processing. In accordance with some embodiments, using block-wise division with blocks of 16×16 pixels can reduce computation involved and allow for a more robust estimation of image features.

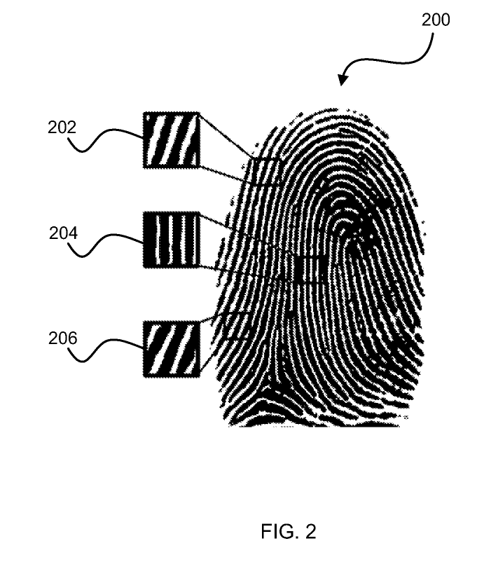

An image projection module 125 can be configured to create two dimensional projections of data using the image sections formed by the image division module 120. Reference will now be made to FIG. 2. FIG. 2 illustrates a fingerprint with some windows highlighted, and shows the distinct, nearly periodic, succession of ridges and valleys with locally constant orientation which is characteristic of fingerprint images. Considering a relatively small window 202, 204, 206 of a fingerprint image 200, for most windows the image may comprise a nearly periodic succession of ridges and valleys of approximately constant rotation. Within a window the rotation is almost constant and does not need to be considered explicitly as an argument in the parameterization. Image points can be embedded in a high-dimensional space by taking patches centered at the pixel location. Specifically, for an image I, an M×M patch corresponding to image point (x, y) can be represented as the ordered set of points {I(u, v):|u−x|≦(M−1)/2 [symbol] |v−y|≦(M−1)/2}. Based on these considerations, the manifold patches obtained from small neighborhoods or windows in a fingerprint image can be topologically equivalent to a circle, with the position of each patch characterized by the phase. Referring again to FIG. 1, the image projection module can be configured to create two dimensional image projections of the data in the image sections and image sections containing fingerprint data will have projections with circular shapes because of the sucession of ridges and valleys of the fingerprint pattern within the image section.

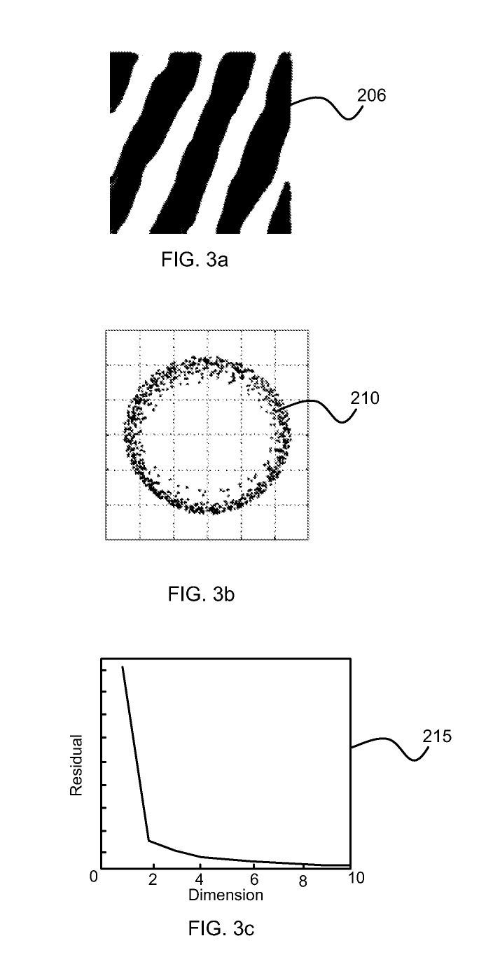

The assertion that the projections of image data from image sections projects to a circular shape can be verified empirically. For example, principal component analysis (PCA) can be applied to the image sections. FIGS. 3a-3c illustrate an example of such an embedding in two dimensions and the residual variance of the pattern as a function of the number of embedded dimensions. FIG. 3a is a section 206 of the fingerprint 200 of FIG. 2. FIG. 3b is a graph illustrating the circular projection of the fingerprint pattern of section 206. FIG. 3b represents a distribution of sample points from the image section which form a circle. The circular shape of FIG. 3b corresponds to the image section of FIG. 3a. FIG. 3c is a residual plot illustrating that most of the variance in the pattern of FIG. 3a lies on the first two-dimensions (since a circle is a 1-D topological structure in a 2-D space). A similar result would be also obtained using other dimensional reduction methods other than PCA.

The blocks formed from the block-wise segmentation can define a neighborhood where PCA or an image projection will be applied. In applying PCA to the blocks, multiple image patches may be used in determining the manifold topology. Thus, a block may typically be larger than patch. Performance of PCA may generally involve using a number of vectors derived from the image. A patch can be comprised of multiple pixels in a region to form a vector. However, blocks and patches can serve different purposes. For example, a patch may be used for the embedding process while blocks can be used for PCA. A patch generally may include multiple pixels in order to obtain context information to determine whether a particular pixel belongs to a ridge, valley, etc.

A reason why linear methods, such as PCA, are able to capture the manifold structure of a fingerprint is because only image sections are being considered, and image sections from a fingerprint image generally comprise lines with an approximately constant rotation and because of the relatively simple ridge/valley pattern of the fingerprint. Unlike a conventional pattern recognition approach based on a static set of features, the systems and methods herein can identify images features which depend on the data. Moreover, since the projection from the image data is found from a neighborhood of points, the projection can incorporate characteristics of the whole neighborhood. Put differently, the projection of each image patch or section can also incorporate context information. In this regard, the systems and methods may share similarities with natural vision systems which extract information by contrast with the context. Knowledge of a manifold topology can uncover the distribution of the data projected onto a feature space. Consequently, an optimal set of features can be derived either directly from the embedding or by measuring properties of the embedding distribution. Deviations from the typical fingerprint pattern can also be easily captured, as will be further described below, since the deviation points have a different manifold structure easily noticeable in the projection from the image section.

The approach described herein uses images having a substantially known topology. For example, the topology of the manifold formed by fingerprint image sections is known and can be used to distinguish image sections corresponding to a fingerprint region and background. Image sections having the structure pertaining to a fingerprint can be detected by measuring if the points projected to two dimensions fall onto a circle. To reduce computation, a block-wise approach can be used with the PCA projection computed for each block. For each block, a composite feature can be computed which measures deviations from an intuitive understanding of the manifold topology. For example, let yⱼⁱ denote the projection of the jth image section in the ith block, and let λᵢ₁ denote the largest eigenvalue of the PCA eigendecomposition. Then, for the ith block, the feature f is:

$${f}_{i} = \frac{1}{N \sqrt{{λ}_{i 1}}} {\sum }_{j = 1}^{N} exp ( - \frac{{‖ {y}_{j}^{i} ‖}^{2}}{2 {λ}_{i 1}} ) ,$$

where N is the number of image sections and ∥yⱼⁱ∥²=Σₖ₌₁^{M}yⱼₖⁱ, with M being the dimension of the image patches (e.g., M=49 for 7×7 pixel image patches).

The feature f expresses information of three different characteristics of the projected image sections, including variance, non-Gaussianity, and symmetry. The variance of the projections onto the first principal component is λᵢ₁. Therefore, windows with good contrast have high variance which yields small values of fᵢ. The exponential term can measure whether projected points are clustered around the origin, as would be the case for image sections containing unstructured values, such as Gaussian noise. For fingerprint windows, the projected points form a well defined circle or circular shape in the tail of the exponential, and thus the exponential will yield small values. The use of only the first eigenvalue in the exponential rather than a covariance matrix can enable verification of the symmetry of the projections to verify the projections are as would be expected for the type of image (in this case, fingerprint regions). When using a covariance matrix in the exponential the projection points will form an elongated ellipse. The exponential will yield higher values for points along the second principal component since these points are closer to the origin (since λᵢ₂≦λᵢ₁).

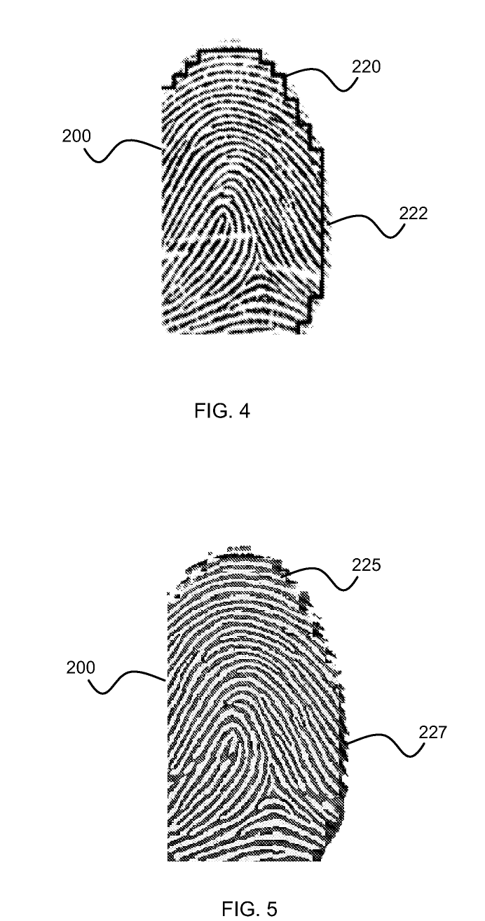

Reference will now be made to FIGS. 1 and 4. The system 100 may comprise a segmentation module 130. The segmentation module can be configured to segment, or separate, a region of interest of the image from the remainder of the image. For example, in a scan of a fingerprint, the image obtained may include fingerprint data as well as other background data. The background data may comprise, for example, data obtained in scanning which does not pertain to the fingerprint, such as a residual fingerprint from a previous scanning, a scanner cover, particles on the scanner surface, objects “viewable” by the scanner which are not obscured by the finger having the fingerprint being scanned, etc. Since the fingerprint in this application contains the image data which is to be recognized, separating the fingerprint from any background, noise, etc. can help facilitate image analysis. The segmentation module can be configured to analyze the image section projections formed by operation of the image division module 120 and the image projection module 125 to determine which of the image section projections comprise a circular shape.

Using the segmentation module to separate the image region actually containing the fingerprint obtained from contact of the fingertip with the sensor from the background region can enable subsequent methods or modules to focus only on the actual fingerprint region to save in computation time. Furthermore, segmentation can enable a more robust extraction of features, such as ridges and minutiae, since segmentation prevents spurious detection of these features in the background simply due to noise. In one aspect, in segmentation the image segments can be smoothed with a 3×3 Gaussian mark (σ=1) or other suitable mark before thresholding. An image section can be classified as a fingerprint region if log(fᵢ+1)<ξ, where ξ is the threshold. The logarithm can be used to reduce the dynamic range of the region. In some aspect, the threshold can be manually selected and may be selected to be ξ=1. In other aspect, for a more systematic method, the threshold can be combined into a linear or nonlinear classifier with a threshold learned from training data for improved results. FIG. 4 illustrates segmentation of the fingerprint region and background. Unlike most previous segmentation methods, post-processing is not necessary to obtain the result in FIG. 4. In fact, for most medium to high quality fingerprints, post-processing is unnecessary with the segmentation approach described herein. Image post-processing procedures often performed using other approaches include image transformations, scaling, interpolation, sub-sampling, or applying any of a number of other heuristics.

As has been described, the image sections comprising a fingerprint pattern will project to a circular shape, while image sections not having such a pattern will not project to a circular shape. Therefore, the image segmentation module can identify the fingerprint, or a region of interest, by identifying the image sections with the circular shaped projections. The image segmentation module can then discontinue consideration of the remainder of the image in further analysis of the image. In one aspect, the remainder of the image data can be discarded. In another aspect, the remainder of the image data may remain intact and/or present, but simply not be considered in further image pattern analysis. For example, FIG. 4 depicts a fingerprint image 200 which has been divided into blocks and a region of interest has been identified. Line 220 illustrates the separation of data within the region of interest from data without the region of interest based on small block image divisions and identification of circular projections from those divisions. Certain points 222 of the fingerprint image can be seen outside of the region of interest in this example. These portions outside the region of interest may fall outside the region because the block divisions containing these portions do not contain sufficient fingerprint pattern data for the projection to result in a circular shape.

Referring to FIGS. 1 and 5, the system 100 may further comprise a line recognition module 135. The line recognition module can be configured to recognize lines within the line pattern on the image. The line recognition module can be used to recognize lines in the region of interest or across the entire image, either before or after image segmentation. In one aspect, the line recognition module may be less computationally expensive by recognizing lines only in the region of interest after image segmentation by the image segmentation module.

In many fingerprint systems, matching fingerprint images involves ridge or line detection. Generally this is accomplished by performing a binary classification of each pixel as belonging to a ridge or a valley. This binary classification can be useful in these systems for alignment of the fingerprints. Often, this binarization process is performed by directly thresholding a fingerprint image after image enhancement processing. Although enhancement processing is applied before thresholding, the use of context information is limited and these prior approaches can easily yield a large number of disconnected components.

The line recognition module 135, in contrast, can utilize the projection of the manifold formed by the fingerprint sections and incorporate information from the whole image section rather than just individual pixels. As has been described, points in the manifold and projections of these points are parameterized by phase. In terms of a sinusoid, the phase expresses the position of a sinusoidal wave with regards to an origin. Hence, within an image section, points belonging to ridges or lines have the same phase. Across multiple image sections phases corresponding to ridges are likely to be different since projection methods may not be sensitive to rotations of the manifold. Accommodation for this difference can be solved by a rotation of the projections.

For detection of ridges, the phase of the points projected can be computed and the phase across blocks can be aligned using an image alignment module 140 by rotating the projections so that a zero phase corresponds to the pixels with darker intensities in the window, the darker intensities being characteristic of ridges. The chosen phase can be any desired phase other than zero as well. Because this alignment involves a rotation of all of the projected points, all of the context from the image section can be used to estimate a best fit rotation.

Referring to FIG. 5, a fingerprint image 200 is shown which has had lines detected by the line detection module 135 and the phase aligned using the image alignment module 140, for the blocks selected after segmentation, with pixels with phases |θ|≦π/3 marked. The marked ridges are shown white in the image, while the gaps are shown as black. The stepwise block segmentation of the region of interest from data outside of the region can be seen at the edges of the fingerprint image. Ridges which have not been detected outside of the region of interest are visible as black lines extending from the white lines representing detected ridges within the region of interest. The line detection module can mark, identify, and/or detect ridges reliably and in some cases even bridge small gaps. The line detection module can even detect ridges under very low contrast.

Referring to FIG. 1, the system 100 may also comprise an image reconstruction module 145. The image reconstruction module can be configured to create a reconstructed image from the lines detected using the line detection module and by using the image section projections which comprise a circular shape. In other words, the image reconstruction module can reconstruct a recognized fingerprint image based on the identified region of interest and the detected lines within the region of interest. The image reconstruction module can be in communication with the image alignment module 140 to properly align the image sections or blocks in forming the reconstructed image.

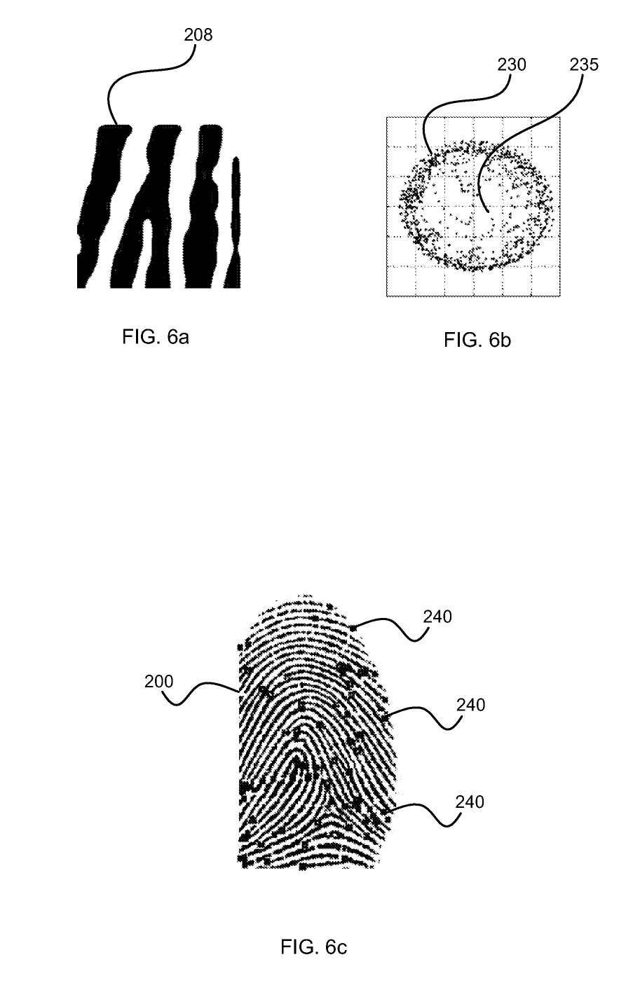

Reference will now be made to FIGS. 1 and 6a-6c. In some embodiments the system may further comprise a variance detection module 150. The variance detection module can be configured to identify variances or deviations from the line pattern with the image section projections which comprise a circular shape by determining whether the image section projections include data near the center of the circular shape.

In the case of fingerprints, deviations from a line pattern are often referred to as minutiae. These minutiae may typically comprise terminations, bifurcations, or joining of ridges, for example. Many current fingerprint matching methods rely exclusively on minutiae detection. Previous approaches for minutia detection generally operate in one of two domains: in the binary fingerprint image, or directly in the grayscale image. In the case of binary fingerprint images, the fingerprint image is typically enhanced and then thresholded to obtain the binary image. The binary fingerprint image can then be thinned to allow for minutia detection in a rather simple manner. A difficulty with this approach is that the thresholding of the fingerprint image can result in many disconnected segments. To avoid such problems, some approaches operate directly on the grayscale image. In the case of grayscale fingerprint images, minutiae detection methods start from a given initial point of a ridge and a direction and iteratively follow the ridges, in steps of a few pixels, by adjusting the step direction towards the next most likely location of the ridge. Minutiae can then be detected when terminations, bifurcations, or joining of the ridge being followed is detected.

The variance detection module 150 can easily detect minutiae by utilizing the fingerprint image section projections. For neighborhoods with a regular pattern of ridges and valleys the manifold topology of image patches is a well defined circle or circular shape, as has been described above. If an image patch contains a minutia, however, the patch will be an outlier with regards to the circular manifold topology. Because points corresponding to image patches containing minutiae are approximately equidistant to points with different phases, the points corresponding to minutiae within image sections will project to the center of the two dimensional circle formed by the regular manifold. In other words, image patches containing minutiae will have small norm when projected onto two dimensions. Minutiae can be found using this basic characteristic. FIG. 6a illustrates a fingerprint image section 208 containing a minutia. FIG. 6b illustrates the circular projection 230 from section 208, including projections 235 to the center of the circular shape.

The norm of the points corresponding to minutiae within image sections in the space where the manifold lies may be comparable to the norm of non-minutia points, but the projection to two dimensions collapses the third dimension, where the minutiae points lie, with regards to the manifold. Plotting the residual variance versus the number of embedding dimensions as was shown in FIG. 3c would, in this case, demonstrate a higher relevance of the third dimension as compared with the plot of FIG. 3c.

To detect minutiae, the variance detection module can construct a “norm image” in which the value of each pixel corresponds to the norm of the projection onto the two dimensional image section centered at that location. The norm image can be thresholded and, for each connected component, a minutia can be marked at the location with the smallest pixel value (i.e., norm). Applying this procedure to the fingerprint image 200 in FIG. 2, and using a 0.4 threshold, minutiae 240 detected can be seen in FIG. 6c for the blocks selected by segmentation. Virtually all true minutiae can be successfully marked using this method. Some spurious minutiae may also be marked in the image due to the simplistic thresholding approach. Better results can be obtained, however, by utilizing slightly bigger image sections. The issues of identifying the region of interest, detecting lines or ridges, and detecting minutiae can thus be integrated together and accomplished with only performing image section projection a single time. In this approach, minutiae can be detected as points for which the regular pattern characteristic of fingerprints does not hold. In this regard, the approach may be similar to how minutiae are detected from thinned binary fingerprint images. In contrast, however, the approach described herein can start from a grayscale fingerprint image directly and without filtering. This is possible since the neighborhood contextual information is utilized in the projection, thereby determining the relevance of each point.

The system 100 can include an image comparison module 155 which may utilize the detected area of interest, lines, and minutiae to compare a first fingerprint image with a second fingerprint image. The image comparison module can be configured to compare characteristics of multiple images and determine similarities or differences between the characteristics of the plurality of images. The image comparison module can use image data available in memory or stored on a computer readable storage device. Lines and minutiae from the images can be compared and images having matching characteristics above a predetermined threshold, such as lines and/or minutiae, can be considered a match.

In some embodiments the system 100 may further comprise a display device 170. The display device can be configured to display the fingerprint image and/or a reconstructed fingerprint image. The system can also include a display module 165 configured to prepare and transmit image data for display to the display device.

As has been described above, and as shown in FIG. 1, the system 100 may further comprise a processor. The processor can be in communication with the various modules described herein. Any particular module can also be in communication with any other of the various modules. The processor can also be in communication with the memory and/or the computer readable medium and may be accessed by the various modules for use in performing the image division, projection, segmentation, etc.

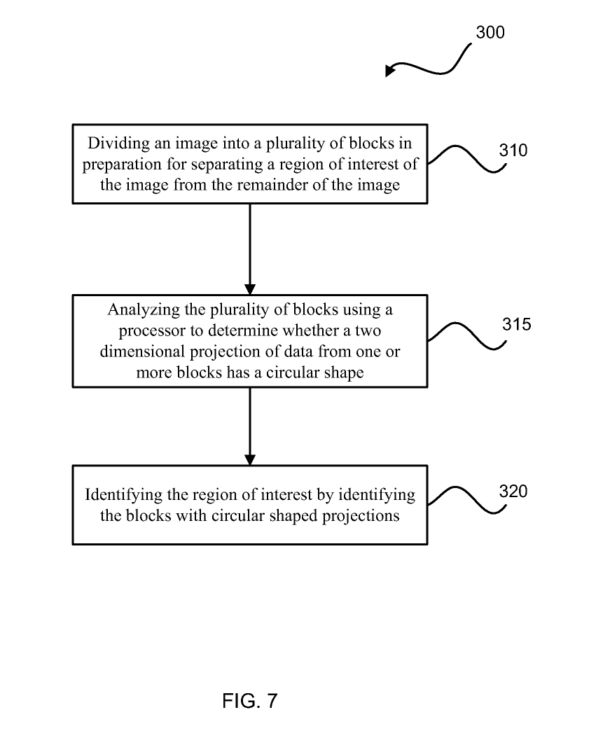

FIG. 7 illustrates a method for image pattern recognition, in accordance with an embodiment. An image can be divided 310 into a plurality of blocks in preparation for separating a region of interest of the image from the remainder of the image. The plurality of blocks can be analyzed 315 using a processor, such as a CPU or other processor, to determine whether a two dimensional projection of data from one or more blocks has a circular shape. The region of interest can then be identified 320 by identifying the blocks with circular shaped projections. The method can further include recognizing an image pattern within the region of interest. The region of interest and/or other data can be stored to a computer readable medium for subsequent comparison with other images. Reconstructed images can also be stored to the computer readable medium. Features or patterns (e.g., the lines, minutiae, etc.) of the images or from the regions of interest can be stored as well. The image patterns can be compared with other image patterns to determine whether the image patterns are the same or substantially similar.

In one aspect, the step of dividing an image into blocks may further comprises dividing an image into blocks where at least one of the blocks contains an image portion comprising a pattern of substantially parallel lines. The method may also further comprise identifying and computing point phases within the blocks in the region of interest. The projection of data from each block can be rotated to align point phases across the blocks. As has been described, blocks with both circular projections and projections to a center of the circular shape can be identified to identify minutiae in the image.

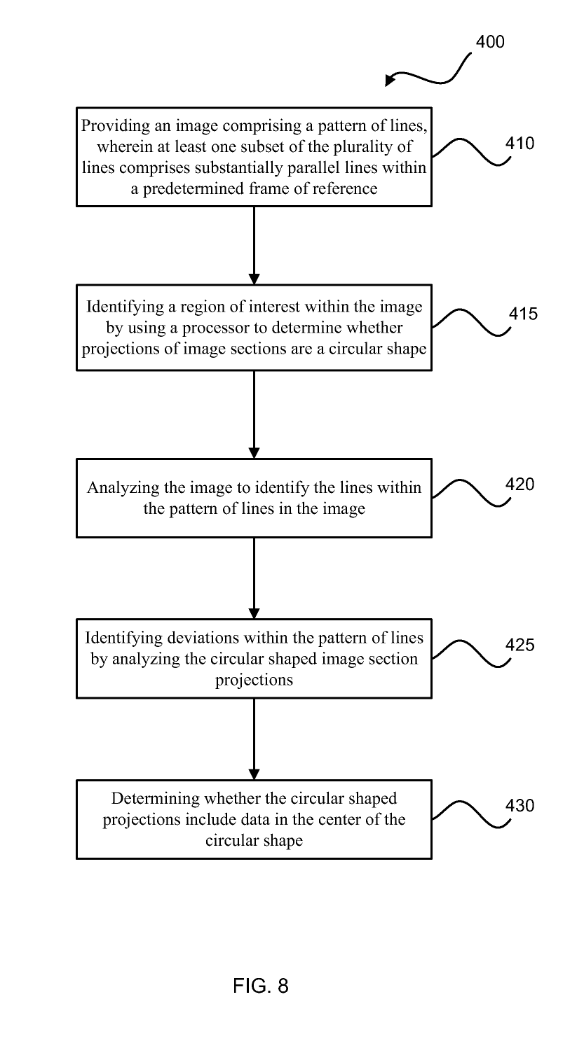

FIG. 8 illustrates a method for image pattern recognition including identification of line pattern deviations, in accordance with an embodiment. An image comprising a pattern of lines is provided 410. At least one subset of the plurality of lines comprises substantially parallel lines within a predetermined frame of reference. The predetermined frame of reference can be an image section, such as sections 202, 204, and 206 shown in FIG. 2. Essentially, the predetermined frame of reference may be any suitable degree of macro or micro view of at least a portion of the image in which the lines appear to be substantially parallel. A region of interest within the image can be determined 415 by using a processor to determine whether projections of image sections have a circular shape. The image can be analyzed 420 to identify the lines within the pattern of lines in the image. Deviations can be identified 425 within the pattern of lines by analyzing the circular shaped image section projections. A determination can also be made 430 as to whether the circular shaped projections include data in the center of the circular shape. Image sections can also be aligned using the identified lines to form an aligned recognized image.

The systems and method for image pattern recognition described illustrate that manifold learning can provide a unified framework for image pattern recognition. Fingerprint and other image analysis problems, such as segmentation, line detection, and minutia detection, which have heretofore been treated as apparently distinct problems, can be solved together in a unified manner using the underlying knowledge of the manifold topology. Furthermore, the principles of manifold learning can be applied to pattern recognition in a single image to infer fundamental characteristics of the image from the topology of the manifold formed by the image.

Though fingerprint images have been the primary focus of the discussion due to the high regularity of patterns, the systems and methods described can be used as a general methodology or systematic approach for image pattern recognition. By understanding and characterizing the manifold topology of image structures relevant to a particular problem, the problem can be simplified to the analysis of a small number of key features. Knowledge of the manifold topology can immediately suggest an optimal approach on how these features can be utilized to solve the problem. The image pattern recognition approaches described can provide at least comparable, if not improved results over current approaches while provided a unified frame and reduced computational cost.

Also within the scope of an embodiment is the implementation of a program or code that can be stored in a machine-readable medium to permit a computer to perform any of the methods described above.

Various functions, names, or other parameters shown in the drawings and discussed in the text have been given particular names for purposes of identification. However, the functions, names, or other parameters are only provided as some possible examples to identify the functions, variables, or other parameters. Other function names, parameter names, etc. may be used to identify the functions, or parameters shown in the drawings and discussed in the text.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology. Accordingly, it is not intended that the invention be limited, except as by the claims set forth below.

1. A method for image pattern recognition, comprising:
dividing an image into a plurality of blocks in preparation for separating a region of interest of the image from the remainder of the image;
analyzing the plurality of blocks using a processor to determine whether a two dimensional projection of data from one or more blocks has a circular shape; and
identifying the region of interest by identifying the blocks with circular shaped projections.

2. A method as in claim 1, further comprising recognizing an image pattern within the region of interest.

3. A method as in claim 2, further comprising storing the region of interest to a computer readable medium for subsequent comparison of features of the image with features of other images.

4. A method as in claim 2, further comprising:
comparing the image pattern with a stored image pattern; and
determining whether the image pattern and the stored image pattern are the same.

5. A method as in claim 1, wherein dividing an image into blocks further comprises dividing an image into blocks where at least one of the blocks contains an image portion comprising a pattern of substantially parallel lines.

6. A method as in claim 1, further comprising identifying and computing point phases within the blocks in the region of interest.

7. A method as in claim 1, further comprising rotating the projection of data from each block to align point phases across the blocks.

8. A method as in claim 1, further comprising identifying the blocks with both circular projections and projections to a center of the circular shape.

9. A method for image pattern recognition, comprising:
providing an image comprising a pattern of lines, wherein at least one subset of the plurality of lines comprises substantially parallel lines within a predetermined frame of reference;
identifying a region of interest within the image by using a processor to determine whether projections of image sections are a circular shape;
analyzing the image to identify the lines within the pattern of lines in the image;
identifying deviations within the pattern of lines by analyzing the circular shaped image section projections; and
determining whether the circular shaped projections include data in the center of the circular shape, wherein the data in the center of the circular shape is representative of the deviations within the pattern of lines.

10. A method as in claim 9, further comprising aligning the image sections using the identified lines to form a recognized image.

11. A method as in claim 9, wherein the image comprises a first image and the method further comprises repeating the method for image pattern recognition with a second image and comparing the second image to the first image.

12. A method as in claim 9, wherein the image comprises a fingerprint and the method further comprises storing fingerprint pattern characteristics on a computer readable medium based on the region of interest and the deviations.

13. A system for image pattern recognition, comprising:
an image receiving module configured to receive an image captured by an image capture device, wherein the image at least partially comprises a line pattern;
an image division module configured to divide the image into a plurality of sections;
a projection module configured to create two dimensional projections of data from the plurality of image sections; and
a segmentation module configured to identify image section projections which comprise a circular shape to identify a region of interest.

14. A system as in claim 13, further comprising a line recognition module configured to recognize lines within the line pattern.

15. A system as in claim 14, further comprising an image reconstruction module configured to create a reconstructed image from the lines and the image section projections which comprise a circular shape.

16. A system as in claim 15, further comprising an image alignment module configured to align the lines from the image sections so that the reconstructed image is an aligned reconstructed image.

17. A system as in claim 13, further comprising a variance detection module configured to identify variances from the line pattern with the image section projections which comprise a circular shape by determining whether the image section projections include data near the center of the circular shape.

18. A system as in claim 13, further comprising a display configured to display the image and the reconstructed image.

19. A system as in claim 13, further comprising an image comparison module configured to compare characteristics of a plurality of images captured by the image capture device and determine similarities or differences between the characteristics of the plurality of images.

20. A system as in claim 13, further comprising a processor in communication with the image division module, the mapping module, the segmentation module, and a computer readable medium configured to store the captured image and the reconstructed image.
